(19) United States
(12) Patent Application Publication
(10) Pub. No.: US 2009/0007178 A1
(43) Pub. Date: Jan. 1, 2009

(54) Video-Based Networking System with a Video-Link Navigator

(75) Inventor: Arturo Artom, Torino (IT)

Correspondence Address: FLIESLER MEYER LLP, 650 CALIFORNIA STREET, 14TH FLOOR, SAN FRANCISCO, CA, 94108, US

(73) Assignee: YOUR TRUMAN SHOW, INC., San Francisco, CA (US)

(21) Appl. No.: 12/138,305

(22) Filed: Jun. 12, 2008

Related U.S. Application Data
(60) Provisional application No. 60/934,342, filed on Jun. 12, 2007.

(51) Int. Cl. H04N 5/445; H04N 7/173

(52) U.S. Cl. 725/40; 725/112

(57) ABSTRACT

A video-based system is described, which provides video link navigation between the various videos uploaded to the system. The video link navigation tool can be a graphically displayed interface that links multiple video nodes to one another and allows users to navigate the videos represented by the nodes. In various embodiments, the video link is a system representation of similarities in content between multiple videos, videos belonging to a same story or sequence, video comments submitted and published in response to a particular video and other forms of video relationships. The video nodes can be displayed as graphical thumbnails on a visual interface and can have various sizes, positions and/or color-codings which indicate the types of relations and other information regarding the videos.

### CLAIM OF PRIORITY

The present application claims the benefit of U.S. Provisional Patent Application No. 60/934,342, entitled VIDEO-BASED NETWORKING SYSTEM WITH A VIDEO-LINK NAVIGATOR, by Arturo Artom, filed on Jun. 12, 2007 (Attorney Docket No. YSTC-01000US0), which is incorporated herein by reference in its entirety.

### CROSS REFERENCE TO RELATED APPLICATION

The following commonly owned, co-pending United States patent application is related to this application and is incorporated by reference herein in its entirety:

U.S. patent application Ser. No. ______, entitled VIDEO-BASED NETWORKING SYSTEM WITH REVIEWER RANKING AND PUBLISHER RANKING, by Arturo Artom, filed on Jun. 12, 2008 (Attorney Docket No. YTSC-01001US1).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to electronic videos and more particularly to providing navigation tools within video-based social networking systems.

### BACKGROUND OF THE INVENTION

Video and other auditory and visual technology has become increasingly popular over the recent years due to its availability on the Internet. Various websites, such as Youtube® have surfaced, which allow video sharing and viewing by way of almost any computing device connected to the Internet. In general, these sites allow a user to upload a video, which can then be viewed and commented on by other users. Thus, once a video is uploaded, users typically need a way to find the video, find other related videos and place videos in various collections or groups.

Accordingly, the ability to navigate, search and/or organize these videos has become a significant issue within this context. The standard ways of representing and arranging data have not adapted themselves optimally for video use because of the unique nature of the video clip. For example, because a video clip may be a part of a larger overall story or collection, an improved way of navigating such videos is desirable. In addition, an interface to represent multiple videos within the context of a social network is needed, one that would account for users and video relationships, video popularity among the users and other information associated with the video.

### BRIEF SUMMARY

Embodiments of the present invention provide a video-based networking system. In exemplary embodiments, members of a network can publish their videos, view videos posted by others, and provide a review of videos posted by others. The videos may be ranked based on the reviews. The members also may be ranked as a publisher and as a reviewer by other members of the network. The video-based networking system can comprise a video-based social networking system. In some embodiments, a video-link (v-link) navigator tool is provided for allowing users to navigate between the various videos and arranging the videos in a particular manner.

### BRIEF DESCRIPTION OF THE DRAWINGS

FIG. 1 is an illustration of an exemplary screenshot of a webpage on the video networking system, in accordance with various embodiments.

FIG. 2 is an illustration of another exemplary screenshot of a webpage on the video networking system, in accordance with various embodiments.

FIG. 3 is an illustration of an exemplary screenshot of the video-link navigator provided on the video networking system, in accordance with various embodiments.

FIGS. 4A and 4B are illustrations of several exemplary screenshots of the video-link navigator having mouse-over functionality, in accordance with various embodiments.

### DETAILED DESCRIPTION

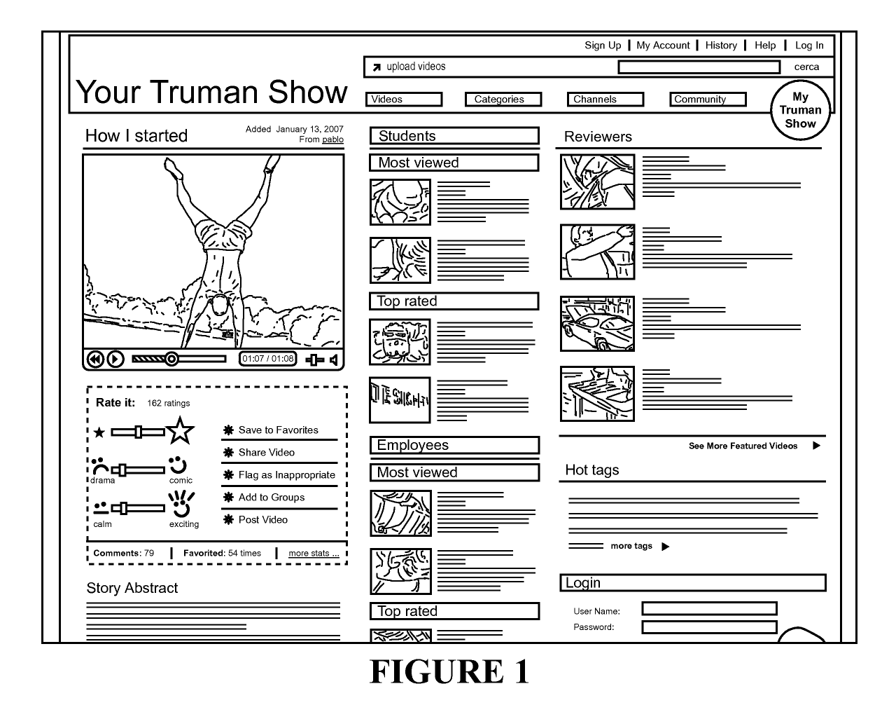

Referring to FIG. 1, an exemplary screenshot of a webpage of the networking system is shown, A left top portion of the webpage comprises a video published by a member. By posting the video, the member becomes a publisher. Additionally, the publisher may post a story abstract associated with the video (e.g., shown at a bottom left portion).

One or more other members may view this video by accessing the video via a webpage. While viewing or after viewing the video, the viewer may rate the video, and thus become a reviewer for the video. As shown in FIG. 1, a ratings section is provided near the video. In exemplary embodiments, the ratings section provides a scale rating system for a plurality of ratings categories. In the example of FIG. 1, the ratings categories comprise an overall category, a drama/comic category, and a calm/exciting category. Alternative embodiments may comprise other ratings categories and may comprise any number of ratings categories (i.e., not limited to three as shown).

The ratings section also comprises a “save to favorites” selection. By saving the video to the member's favorites, a “favorited” count is incremented (e.g., “favorited 54 times”). The ratings section further provides other statistics such as number of comments left by reviewers.

In exemplary embodiments, a middle portion of the webpage provides a listing of videos based on rankings. For example, most viewed and top rated videos may be listed. The listing may be based on particular types of members. In the present embodiment, the listings are ranked for students and employees. Alternative embodiments may utilize other types of members for ranking purposes and other categories of ranking (e.g., most reviews, etc.).

The exemplary webpage may further comprise a reviewers' portion (e,g., on a right side of the webpage). In exemplary embodiments, the reviewers' portion provides links to reviews posted by reviewers of the current video and/or other videos. By selecting one of the links, the viewer sees the review posted by the reviewer. According to exemplary embodiments, the viewer may rate the reviewers' reviews.

In some embodiments, links to videos or member webpages may be listed based on the publisher/video score and/or the reviewer score. Thus, for example, the middle portion of the webpage, or other portion, may provide a listing of video links based on the top publisher scores or the top reviewer scores.

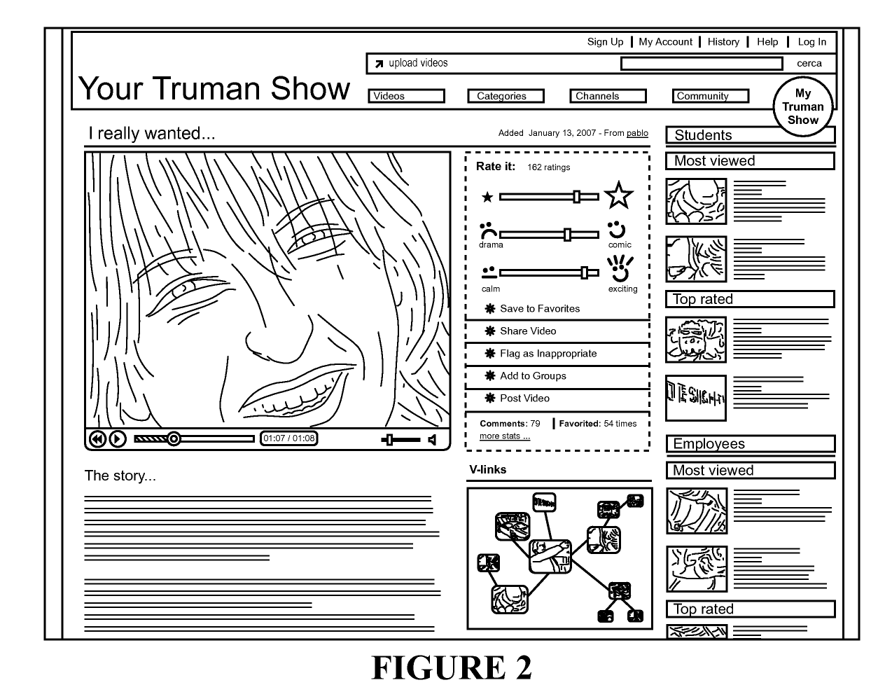

Referring to FIG. 2 another exemplary screenshot of a webpage is shown. On this webpage, a v-link (video-link) portion is shown on the webpage. In some embodiments, the v-link portion provides links from a member's video to other videos that are similar. In other embodiments, the v-link portion provides links from a present video (e.g., the video currently viewed) to other similar videos. In yet other embodiments, the v-links may link videos of a same storyline together.

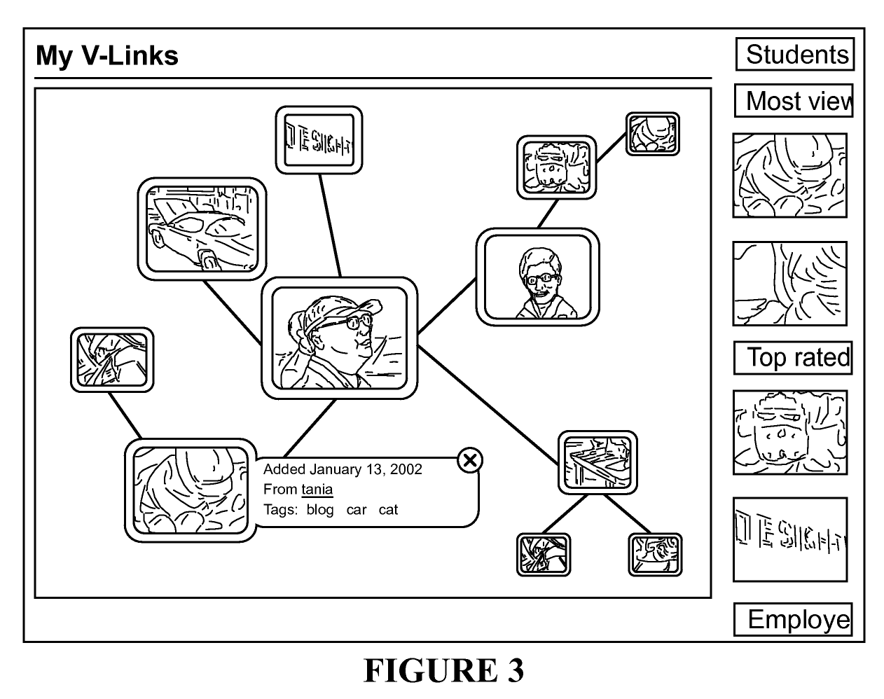

A larger version of the v-link portion is shown in FIG. 3. Each video node comprises a video. A video node may be coupled to one or more other video nodes. Any number of links from a single video node may be provided. Details of a video node may be obtained by moving a cursor over the video node. As a result, a details display, as shown in FIG. 3, maybe presented. In exemplary embodiments, the details display may comprise information regarding when the video was published, who the publisher is, and any tags associated with the video. Tags may be utilized to associate an idea or data with the video, and may be provided by the publisher, a viewer, or a reviewer. In one example, the tags may be provided by any viewer and/or any reviewer.

In some embodiments, a size of a video node is determined by a number of visits. Therefore, a video that has a large number of viewers will have a video node that is larger in size than a video node of a video that has fewer viewers.

In exemplary embodiments, a set of dynamic rules are associated with the v-links. For example, if a v-link between two video nodes is not utilized within a predetermined time period (e.g., one week), then the v-link may be deleted. Other dynamic rules may be contemplated.

In exemplary embodiments, viewers may indicate or determine if a v-link is not appropriate. For example, if a viewer not associated with the video nodes accesses a video via a v-link and believes the v-link is not applicable, then the viewer may flag the v-link. In one embodiment, the flag is an indication or message to a network host that the v-link is not appropriate. An administrator of the network host or a publisher of one of the affected videos may determine if the v-link should be removed.

If the viewer is a publisher of one of the linked videos, then the viewer may, according to one embodiment, delete the v-link.

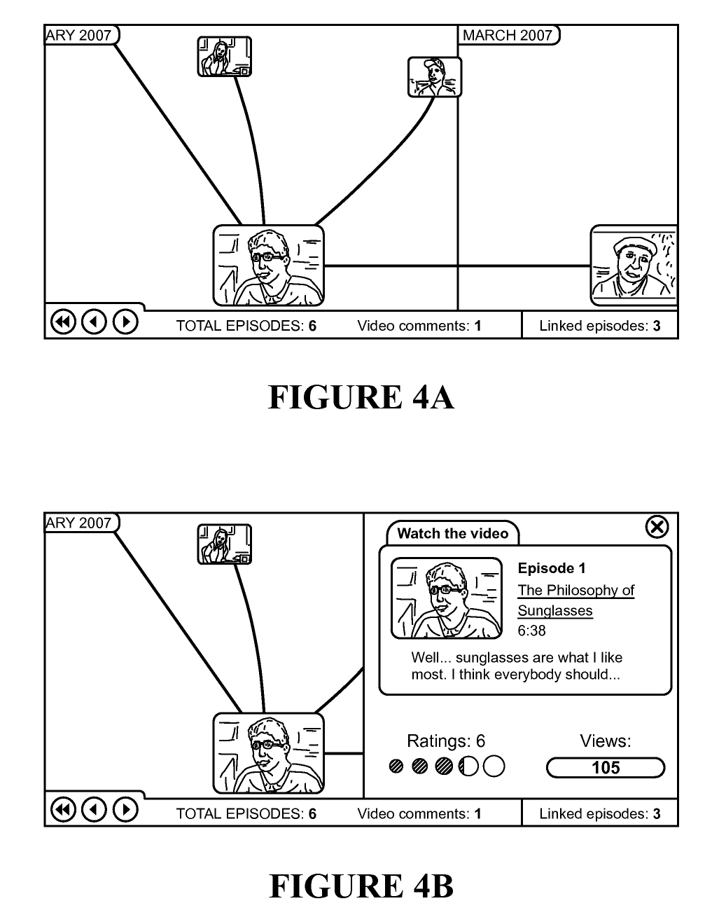

Referring to FIGS. 4A and 4B, two alternative screenshots of the v-link navigator are shown. In these figures, the mouse-over functionality is illustrated whereby a set of information regarding the video is displayed when a mouse cursor is moved over the video node. For example, in the FIG. 4A, various nodes are displayed, while FIG. 4B illustrates a display box having a titlebar “Watch the video,” which is displayed once a mouse cursor is moved onto the video node shown in FIG. 4A. The display box can present a set of information regarding the video, including but not limited to the title, the abstract, the length, the description and the like. As illustrated, the nodes can be connected to each other by way of video-links (v-links) and the user can navigate the various nodes by using these v-links.

In various embodiments, v-links are relational links among videos. For example, a v-link establishes a link among videos and can be created as a system representation of:

a. Similarities in content of the linked videos;

b. Videos belonging to a same story (e.g., series of episodes);

c. Video comments submitted and published in response to a specific video;

d. Videos that are somehow related to each other.

The V-links Navigator component can allow the user to move in an easy and intuitive way within the v-links. Toolbar Arrows and pointers can manage horizontal, vertical and directional scrolling. Clicking and holding a mouse pointer button can control the “drag” function.

The video node can be represented as a thumbnail. In one embodiment, the size, position and/or color coding of the thumbnail can indicate the relationships and other information regarding the videos. For example, by using thumbnail icons' position, size and color-coding, users can intuitively understand what type of relation exists between videos. The largest icons arranged horizontally can represent the main story line and include all the videos belonging to the same story or series. Icons placed around main story line icons, can represent video comments (indicated by one color frame or shape) and links to similar videos (indicated by another color frame or shape). By using color-coding and labels, videos belonging to a story line can be placed on a visual timeline. By scrolling horizontally the system can provide a visual representation of when videos were created, uploaded and linked.

In various embodiments, v-links can be created automatically or manually. For example, in one embodiment, videos belonging to the same story line are automatically linked by the system. Links to videos belonging to other story lines can be generated upon a specific request of a user of the system.

The V-link Navigator toolbar can contain information about the user and the videos contained in the navigator. By way of example, the information can specify the total number of videos, the total number of external links, the number of video comments and the like.

In various embodiments, with specific “mouse over” functionality on the thumbnail, users can retrieve additional information about the specific video. By way of example, when a mouse cursor is placed over the thumbnail, information can be displayed regarding the Video title, the author of the video, the video duration, the abstract, the score associated with the video, the total number of reviews and the like.

The above-described functions and components can be comprised of instructions that are stored on a computer readable storage medium. The instructions can be retrieved and executed by a processor. Some examples of instructions are software, program code, and firmware. Some examples of storage medium are memory devices, tape, disks, integrated circuits and servers. The instructions are operational when executed by the processor to direct the processor to operate in accord with embodiments of the present invention. Those skilled in the art are familiar with instructions, processor(s), and computer readable storage medium.

The various embodiments include a computer program product which is a storage medium (media) having instructions stored thereon/in which can be used to program a general purpose or specialized computing processor(s)/device(s) to perform any of the features presented herein. The storage medium can include, but is not limited to, one or more of the following: any type of physical media including floppy disks, optical discs, DVDs, CD-ROMs, microdrives, magneto-optical disks, holographic storage, ROMs, RAMs, PRAMS, EPROMs, EEPROMs, DRAMs, VRAMs, flash memory devices, magnetic or optical cards, nanosystems (including molecular memory ICs); paper or paper-based media; and any type of media or device suitable for storing instructions and/or information. The computer program product can be transmitted in whole or in parts and over one or more public and/or private networks wherein the transmission includes instructions which can be used by one or more processors to perform any of the features presented herein. In various embodiments, the transmission may include a plurality of separate transmissions.

The present invention has been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present disclosure and claims.

What is claimed is:

1. A method for associating videos in a video-based networking system, said method comprising:
maintaining a plurality of videos on the video-based networking system for viewing by one or more users of the video-based networking system;
receiving a request to establish a link between a first video and a second video;
linking the first video to the second video; and
generating an interface that displays said link between the first video and the second video such that the one or more users of the video-based networking system are enabled to navigate from the first video to the second video by using said link.

2. The method of claim 1 wherein said link is a system representation of one or more of:
similarities in content between the first video and the second video, a single story that includes both the first video and the second video, video comments submitted for the first video or the second video, and a relationship between the first video and the second video.

3. The method of claim 1 wherein the first video and the second video are represented by graphically displayed nodes, each node having one or more of position, size and color-coding.

4. The method of claim 1 wherein at least one of the position, size and color-coding of a node is indicative of an attribute of the video associated with the node.

5. The method of claim 1 wherein the first video and the second video are automatically linked by the video-based networking system.

6. The method of claim 1 further comprising receiving an indication of an inappropriate link between the first and second videos.

7. The method of claim 1 further comprising deleting an inappropriate link between the first and second videos.

8. The method of claim 1 further comprising displaying the videos as video nodes and the link as a v-link on a graphical display.

9. The method of claim 1 wherein the linked first and second video are from a same storyline.

10. The method of claim 1 further comprising providing a details display.

11. A video-based networking system for providing video-link navigation, said system comprising:
a server that provides a plurality of videos for viewing by one or more users of the video-based networking system; and
an interface that displays a graphical video-link between a first node and a second node to the one or more users, said first node and said second node each representing a different video on the server, wherein the video-link enables the one or more users to navigate between the videos provided by the server.

12. The video-based networking system of claim 11 wherein said video-link is a system representation of one or more of:
similarities in content between the videos represented by the first node and the second node, a single story that includes videos represented by both the first node and the second node, video comments submitted for the first node or the second node, and a relationship between the videos represented by the first node and the second node.

13. The video-based networking system of claim 11 wherein the first node and the second node are graphically displayed as having one or more of position, size and color-coding.

14. The video-based networking system of claim 13 wherein at least one of the position, size and color-coding of a node is indicative of an attribute of the video associated with the node.

15. The video-based networking system of claim 11 wherein the first video and the second video are automatically linked by the video-based networking system.

16. The video-based networking system of claim 11, further comprising:
receiving an indication of an inappropriate link between the first and second videos.

17. The video-based networking system of claim 11, further comprising:
deleting an inappropriate link between the first and second videos.

18. The video-based networking system of claim 11 wherein the linked first and second video are from a same storyline.

19. The video-based networking system of claim 11, further comprising:
providing a details display.

20. A computer-readable medium carrying one or more sequences of instructions for associating videos in a video-based networking system, which instructions, when executed by one or more processors, cause the one or more processors to carry out the steps of:
maintaining a plurality of videos on the video-based networking system for viewing by one or more users of the video-based networking system;
receiving a request to establish a link between a first video and a second video;
linking the first video to the second video; and
generating an interface that displays said link between the first video and the second video such that the one or more users of the video-based networking system are enabled to navigate from the first video to the second video by using said link.
